(19) United States
(12) Patent Application Publication
(10) Pub. No.: US 2021/0358294 A1
(43) Pub. Date: Nov. 18, 2021

(54) HOLOGRAPHIC DEVICE CONTROL

(71) Applicant: Microsoft Technology Licensing, LLC, Redmond, WA (US)

(72) Inventors: Hiranmay Parashar, Seattle, WA (US); Jean Khawand, Sammamish, WA (US)

(21) Appl. No.: 16/875,075

(22) Filed: May 15, 2020

(51) Int. Cl. G08C 17/02; G06K 9/00; G06F 3/01

(52) U.S. Cl. CPC G08C 17/02; G06K 9/00671; G08C 2201/91; G08C 2201/34; G06F 3/012

(57) ABSTRACT

A remote control device controls a physical controlled device in a physical user space using a virtual control in a mixed reality environment, including positioning, by a remote control device, the virtual control associated with the physical controlled device within a visual user space displayed by the remote control device and viewable within a field of view of a user. The remote control device detects a first user activation of the virtual control within the visual user space and generates a remote control instruction representing the first user activation of the virtual control by the user, the remote control instruction being supported by the physical controlled device to perform the first user activation on the physical controlled device. The remote control device transmits the remote control instruction from the remote control device to the physical controlled device, responsive to detecting the first user activation.

### BACKGROUND

A mixed reality environment presents a combination of physical elements and virtual elements to present visualization and experiences within a visual user space that is within the field of view of the user. Physical elements exist in a physical user space, such as the room in which the user is standing (e.g., a light bulb or a microwave oven). In contrast, virtual elements are digitally-generated elements that can be presented to the user in some combination with the physical elements within the visual user space. In some mixed reality environments, virtual elements overlay (and/or “underlay”) physical elements in the user's field of view with spatial registration that enables geometric persistence relating to placement and orientation within the real world.

For example, in one implementation, the user can wear a transparent or translucent display or set of displays through which the user can see the physical elements in his or her physical space and on which the user can see displayed renderings of virtual elements. In other implementation, the physical elements can be captured (e.g., by a forward-facing camera and rendered in the displays along with the virtual elements. The physical and virtual elements appear, in many cases, to be combined in the display(s) as part of the same immersive visual reality.

Some implementations further enhance this immersive sensation using various sensors, a high-definition stereoscopic 3D optical head-mounted display, and spatial sound to allow for augmented reality applications, with a natural user interface that the user interacts with through gaze, voice, and hand gestures. In other implementations, simpler devices, such as a camera-equipped mobile phone or tablet computer can display physical elements and virtual elements in the display and receive user input through a touch screen, microphones, and other sensors.

A mixed reality environment will typically provide a user with a view of a physical controlled device, allowing the user to directly manipulate the controls of the physical controlled device (e.g., pressing physical buttons on a physical control panel of a physical microwave oven). However, remotely controlling physical controlled devices with virtual control elements in a mixed reality environment is an unavailable, overly complicated, and/or a non-intuitive experience for most users.

### SUMMARY

The described technology provides remote control of a physical controlled device in a physical user space using a virtual control in a mixed reality environment, including positioning, by a remote control device, the virtual control associated with the physical controlled device within a visual user space displayed by the remote control device and viewable within a field of view of a user. The remote control device detects a first user activation of the virtual control within the visual user space and generates a remote control instruction representing the first user activation of the virtual control by the user, the remote control instruction being supported by the physical controlled device to perform the first user activation on the physical controlled device. The remote control device transmits the remote control instruction from the remote control device to the physical controlled device, responsive to detecting the first user activation.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example mixed reality environment for holographic device control.

FIG. 2 illustrates an example remote control device in the form of a head-mounted display (HMD) device to be worn and used by a user).

FIG. 3 illustrates an example of activating a virtual control in a mixed reality environment.

FIG. 4 illustrates another example of activating a virtual control in a mixed reality environment.

FIG. 5 illustrates yet another example of activating a virtual control in a mixed reality environment, wherein the virtual control exhibits multiple modes.

FIG. 6 illustrates an example registration of a virtual control for a physical device in a mixed reality environment.

FIG. 7 illustrates an example rendering and activation of a virtual control for a physical device in a mixed reality environment.

FIG. 8 illustrates example hardware and software components and subsystems of an example remote control device and an example physical controlled device.

FIG. 9 illustrates example operations for remotely controlling a physical controlled device in a physical user space using a virtual control in a mixed reality environment.

FIG. 10 illustrates example operations for executing a virtual control object associated with a physical controlled device in a mixed reality environment.

FIG. 11 illustrates exampled hardware and software that can be useful in implementing the described technology.

### DETAILED DESCRIPTIONS

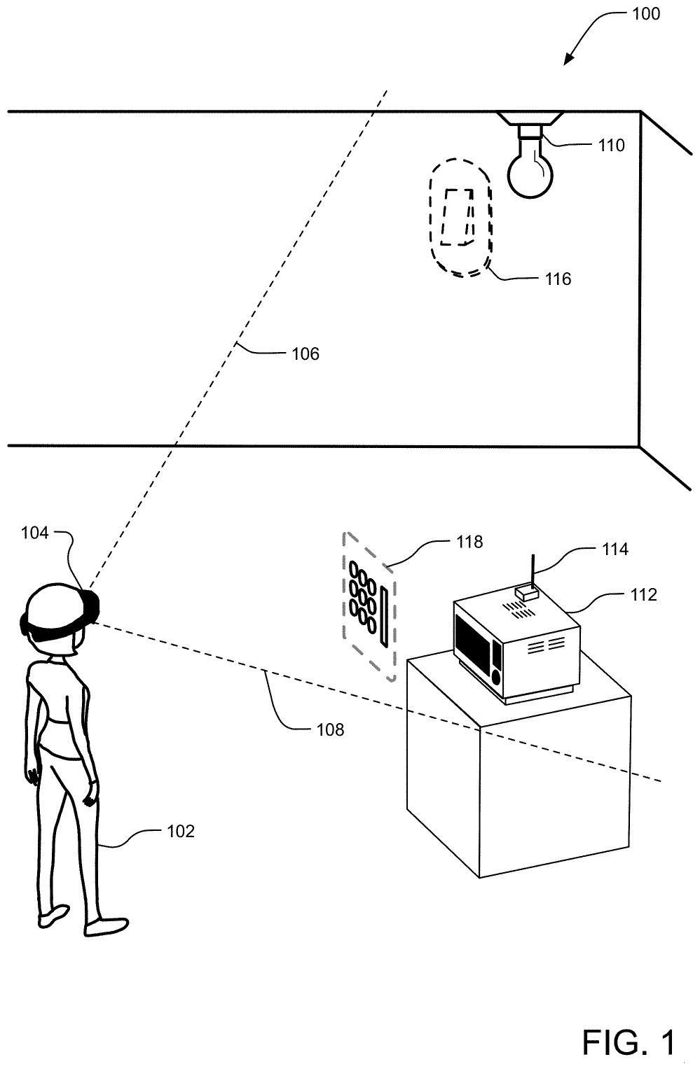

FIG. 1 illustrates an example mixed reality environment 100 for holographic device control. A user 102 is positioned within a physical user space (e.g., the room), wearing a remote control device in the form of a head-mounted display (HMD) device 104. Her field of view is shown between the dashed line 106 and the dashed line 108 to represent a viewable volume that is visible by the user 102. As the user's head and/or the HMD device 104 changes position and orientation, the field of view changes accordingly.

Within her illustrated field of view, the user 102 can view physical objects within the physical user space. The physical objects are shown in solid lines and include a light 110, a microwave oven 112, a cube on which the microwave oven 112 sits, and boundaries of the room (e.g., floor, wall, ceiling). The light 110 includes storage, processing features, and communications capabilities to support holographic device control. The light 110 and the microwave oven 112 are physical controlled devices that may or may not have physical controls. For example, the microwave oven 112 has a physical control panel on its front surface. Likewise, the light 110 may be connected to a light switch on a wall, although the described technology can make such physical controls unnecessary. The physical controls can be replaced in some designs with virtual controls of a holographic device control solution.

The microwave oven 112 is illustrated as an example of a legacy device that is not designed originally for holographic device control. As such, the microwave oven 112 is instrumented with a communication device with a directional antenna 114. The communication device equips the microwave oven 112 with storage, processing features, and communication capabilities to support holographic device control. The communication device is connected to (via wireless or wired connections) the microwave oven 112 to control functions of the microwave oven 112 and provides the wireless communications with the HMD device 104.

When turned on, the light 110 and the microwave oven 112 (instrumented with the communication device) periodically transmit localizable beacons (e.g., based on Bluetooth 5.1 or other localization technologies) into the physical user space. Typically, such localizable beacons have a limited range that would fill most rooms. For example, Bluetooth 5.1 provides directional antenna support and is currently rated for a physical range of 10 m to 100 m, although other ranges may be available depending on the localizable beacon technology employed. The range can also vary based on ambient electromagnetic noise, electromagnetic shielding, and transmission power of the localizable beacons. It should be understood that some devices may enter a low power mode in which they do not continually broadcast beacons but instead will respond to “wake up” instructions from the HMD device 104 before restarting the beacon broadcasts.

If the physical controlled device has not yet registered with the HMD device 104, upon receiving localizable beacons from the physical controlled device, the HMD device 104 can localize the physical controlled device in the physical user space, e.g., within 10 cm accuracy in three dimensions for Bluetooth 5.1. For example, the HMD device 104 may begin to receive such beacons after entering a room containing physical controlled devices with holographic device control capabilities (e.g., with the light 110 or with the communication device connected to the microwave oven 112). Responsive to receiving such beacons, the HMD device 104 can indicate to the user 102 that a physical controlled device is offering to be controlled by holographic device control, including without limitation audio, visual, and/or haptic effects. For example, the HMD device 104 can display a virtual indicator (e.g., an icon, sparkles, a shimmer effect, a translucent color overlay) that visually overlaps the physical controlled device on one or more display within the user's field of view in the HMD device 104 to indicate that the physical controlled device is offering holographic device control functionality.

Responsive to instructions by the user, such as activating (e.g., “touching”) the virtual indicator, the HMD device 104 can respond to the physical controlled device's offer by attempting to pair with the physical controlled device. It should be understood that activation of a virtual indicator may be inferred by co-locating the physical object (e.g., the user's finger) in the physical user space and the virtual control in the virtual user space. Bluetooth 5.1 and other localization and communication protocols provide standards for such pairing operation. For example, after detecting the activation of the visual indicator, the HMD device 104 can send a Bluetooth pairing request to the physical controlled device (or vice versa) to initiate the pairing operation. Once paired, the HMD device 104 and the physical controlled device can establish a security relationship and a secure communication connection to allow holographic device control of the physical controlled device by the HMD device 104, as will be described below.

In other implementations, pairing and a secure communication connection may not be employed. For example, a vending machine may have lower security requirements than an enterprise system. Accordingly, a non-secure communication connection is sufficient for certain operations of the interaction between the HMD device 104 and the vending machine.

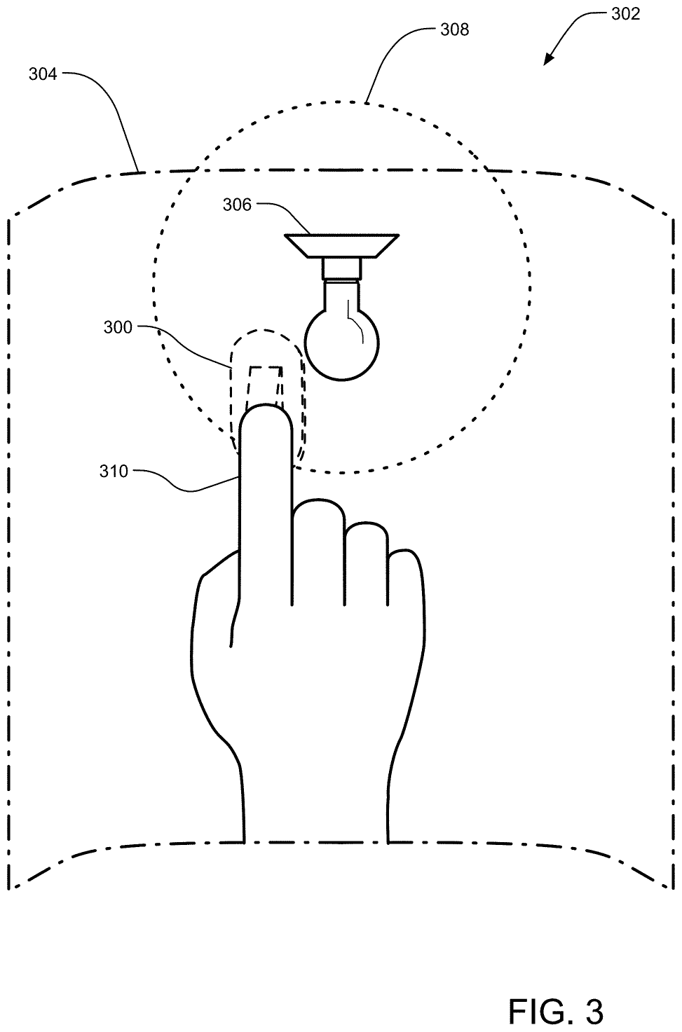

Having established a secure communication connection, the HMD device 104 then obtains a virtual control that corresponds to the particular physical controlled device. A virtual control is a software control object (e.g., a digital software object encoding instructions for functional and graphical characteristics of the virtual control) associated with the physical controlled device and is positioned within the user's field of view in the HMD device 104. In one implementation, the virtual control is visible within the user's field of view in the HMD device 104 in the proximity of the associated physical controlled device. The HMD device 104 can rely on the localizable beacons emitted by the physical control device to determine this location proximity. For example, a virtual switch control 116 is illustrated as being displayed to the user 102 via one or more displays of the HMD device 104 in the visual proximity of the light 110. Likewise, the virtual panel control 118 is illustrated as being displayed to the user 102 via one or more displays of the HMD device 104 in the directional antenna 114 of the communication device connected to the microwave oven 112. As shown in FIG. 3, the virtual control is displayed within a proximity region around a view axis (not shown) between the HMD device 104 and the communications system (e.g., the directional antenna 114, an antenna in the light 110) of the corresponding physical controlled device.

If the physical controlled device has registered with the HMD device 104 already, then the HMD device 104 can reconnect to it via the secure communication connection established by the pairing upon receipt of the localizable beacons from the physical controlled device. At this point, the holographic device control of the physical controlled device by the HMD device 104 may begin by displaying the virtual control positioned within the user's field of view in the HMD device 104.

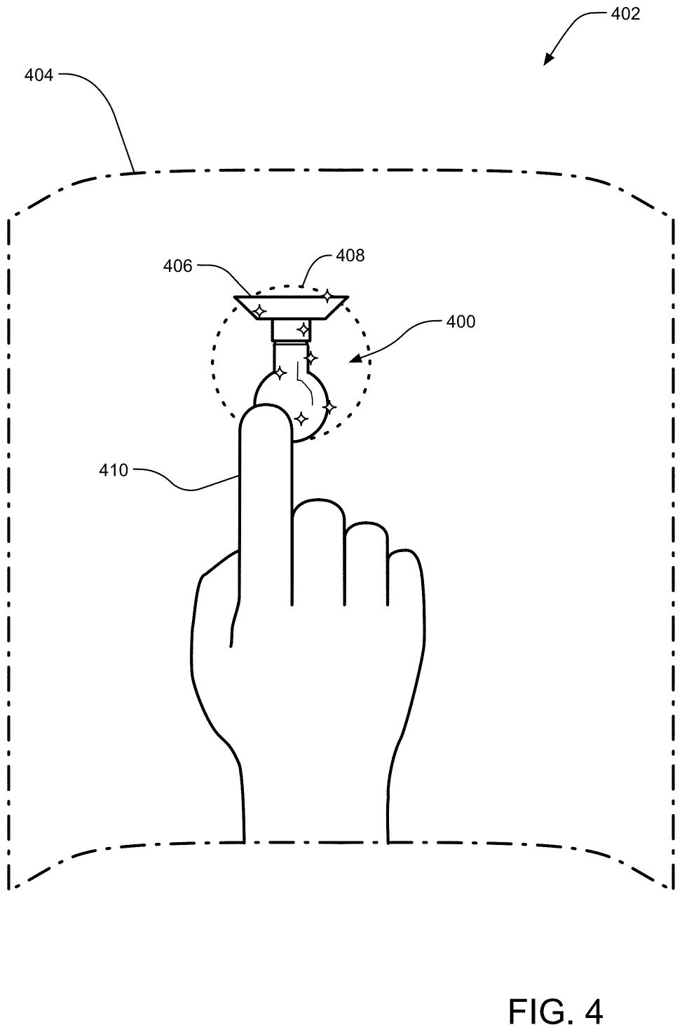

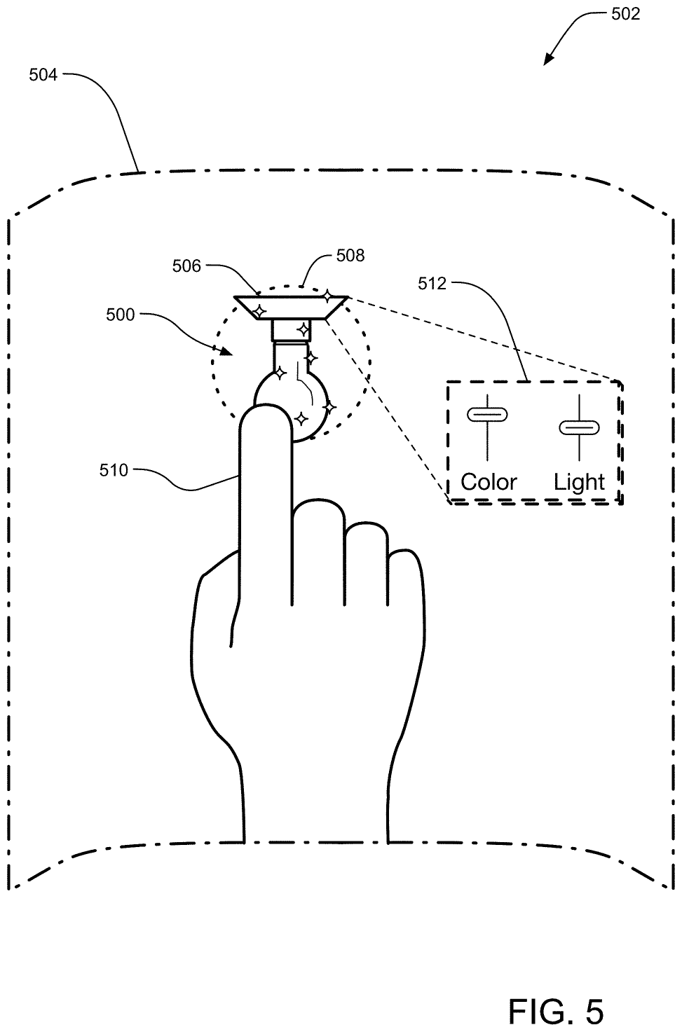

In other implementations, the virtual control need not be visible or need not be displayed as a control. For example, the virtual control object may encode instructions for a transparent or translucent overlay that overlaps the physical controlled device within the user's field of view in the HMD device 104. In another implementation, the virtual control may be displayed as a colored icon, a sparkling effect, a shimmering effect, or another digitally-rendered effect overlapping or in visual proximity of the physical controlled device within the user's field of view in the HMD device 104. See, for example, FIG. 4 and the related description. In yet another representation, the virtual control may exhibit multiple modes, such as initially displaying a virtual switch or a sparkling overlay that, when activated, converts to a control panel. See, e.g., FIG. 5 and the related description.

The virtual control object that encodes the instructions for positioning, displaying, and/or executing the holographic device control functionality may be obtained by the HMD device 104 in a variety of ways. In one implementation, the virtual control object is stored in firmware or other onboard storage of the physical controlled device and communicated via the secure communication connection established by the pairing exchange. In another implementation, the physical controlled device can communicate a virtual control object identifier (e.g., a URL to a virtual control object library or service from which the HMD device 104 can download the code for the virtual control object associated with the physical controlled device). In yet another implementation, the HMD device 104 can recognize a physical pattern (e.g., a QR code or the physical attributes of the device itself, such as a marked model or vendor name, the locations of buttons, and/or device shape) on or associated with the physical controlled device and compare the recognized pattern against patterns of known physical controlled devices. If a match is made, then the HMD device 104 can download a virtual control object associated with that known physical controlled device. The match may be associated with the specific instance of the physical controlled device (e.g., a virtual control object for each unique device), with the type of physical controlled device (e.g., a virtual control object for the same type or similar types of devices), or with generic or standard categories of devices (e.g., simple lighting devices may comply with a generic or standard template of lighting equipment that is mapped to a generic version of a virtual control object for simple lighting devices).

Having obtained the virtual control object associated with the physical controlled device, hardware processors in the HMD device 104 execute the virtual control object and position the corresponding virtual control (whether visible or invisible) within the user's field of view in the HMD device 104. In one implementation, the HMD device 104 positions the virtual control to overlap the physical controlled device in the user's field of view. In another implementation, the HMD device 104 positions the virtual control within a proximity region around a view axis (not shown) between the HMD device 104 and the communications system (e.g., the directional antenna 114, an antenna in the light 110) of the corresponding physical controlled device.

The user 102 can then activate the virtual control to remotely control the associated physical controlled device. For example, in the case of the virtual switch control 116, the user 102 can reach forward within her field of view through the HMD device 104 and “touch” the virtual switch control 116 to turn the light 110 on and off. In the case of the virtual panel control 118, the user 102 can reach forward within her field of view through the HMD device 104 and “touch” buttons on the virtual panel control 118 to turn the operate the microwave oven 112. Each user action performed through a virtual control causes the HMD device 104 to transmit a remote control instruction through the secure communication connection to the corresponding physical controlled device, which executes the instructed function upon receipt. Furthermore, the physical controlled device may also transmit device information (e.g., instruction acknowledgments, state change indicators) through the secure communication connection to the HMD device 104. For example, the microwave oven may communicate a “time remaining” value in a countdown time of a cooking operation, and the HMD device 104 can display that value in the virtual control or in some other location. In this manner, the user 102 can use the HMD device 104 to remotely control the operation of a physical controlled device, such as a light 110 or a microwave oven 112. Furthermore, the physical controlled device may also exchange other data that is not limited to control data (e.g., a music stream from a jukebox).

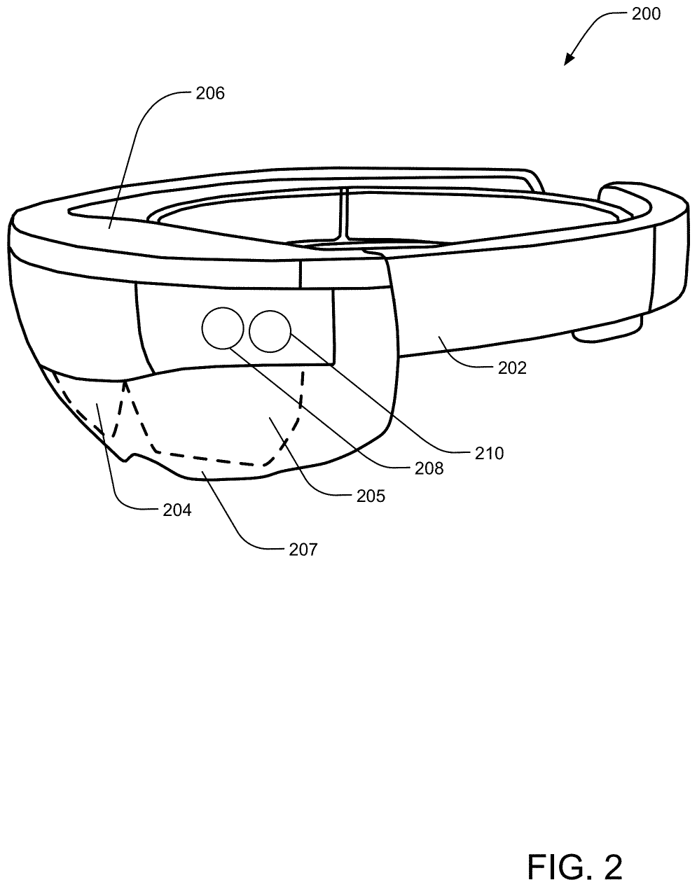

FIG. 2 illustrates an example remote control device in the form of a head-mounted display (HMD) device 200 to be worn and used by a wearer (e.g., a user). Alternative remote control devices may include without limitation mobile phones, tablet computers, gaming devices and accessories, and other electronic devices capable of supporting a mixed reality environment. The illustrated remote control device includes a frame 202. The frame 202 supports stereoscopic, see-through display componentry, which is positioned close to the wearer's eyes. The HMD device 200 may be used in mixed-reality applications, where real-world imagery is admixed with virtual display imagery. It will be appreciated that in other examples, the HMD device 200 may take other suitable forms in which one or more transparent, semi-transparent, and/or non-transparent displays are supported in front of a viewer's eye or eyes. It will also be appreciated that the example remote control device may take the form of different electronic devices, including without limitation a mobile phone, a tablet computer, and gaming systems.

The HMD device 200 includes a right display panel 204 and a left display panel 205, which may be wholly or partly transparent from the perspective of the wearer, to give the wearer a clear view of his or her physical surroundings in the physical user space. For example, the appearance of the physical environment may be augmented by graphical content (e.g., one or more pixels each having a respective color and brightness) that is presented via the display panels 204 and 205 to create a mixed reality environment. The HMD device 200 is also fitted with a transparent or translucent shield lens 207, although other implementations may be employed.

In the illustrated implementation, each display panel 204 and 205 includes a backlight and a liquid-crystal display (LCD) type microdisplay. The backlight may include an ensemble of light-emitting diodes (LEDs), such as white LEDs or a distribution of red, green, and blue LEDs. The backlight may be configured to direct its emission through the LCD microdisplay, which forms a virtual display image based on control signals from a computer subsystem 206. The LCD microdisplay may include numerous, individually addressable pixels arranged on a rectangular grid or other geometry. In some embodiments, pixels transmitting red light may be juxtaposed to pixels transmitting green and blue light, so that the LCD microdisplay forms a color image. In other embodiments, a reflective liquid-crystal-on-silicon (LCOS) microdisplay or a digital micromirror array may be used in lieu of the LCD microdisplay. Alternatively, an active LED, holographic, or scanned-beam microdisplay may be used to form right and left display images. Although the drawings show separate right and left display panels, a single display panel extending over both eyes may be used instead.

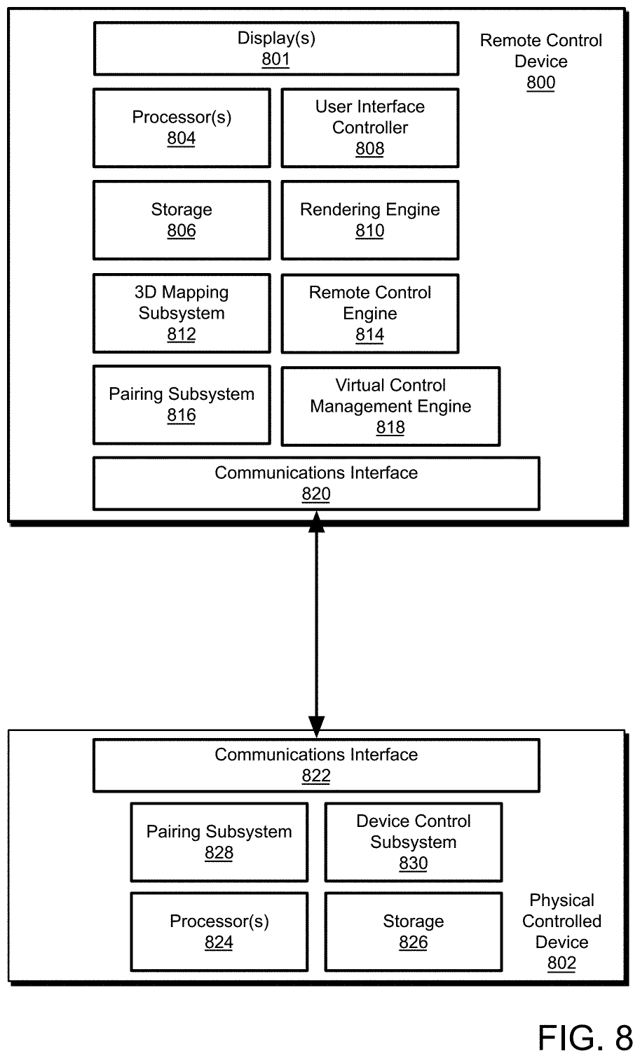

The computer subsystem 206 is operatively coupled to the display panels 204 and 205 and to other display-system componentry. The computer subsystem 206 may include hardware and software components, as discussed in more detail below with respect to FIG. 8, which are in communication with the various sensors and systems of the HMD device and display. In one example, the storage machine may include instructions that are executable by the logic machine to receive sensor data from the sensors and predict a future pose of the HMD device, request a rendered virtual image via a communications machine, adjust a rendered virtual image, and display an adjusted virtual image via right and/or left display panels. The HMD device 200 may include an accelerometer, gyroscope, and magnetometer, stereo audio speakers (e.g., left and right), a color camera 208, and a depth camera 210.

The HMD device 200 may also include a head tracking system that utilizes one or more motion sensors to capture pose data and thereby enable position tracking, direction and orientation sensing, and/or motion detection of the user's head and/or the HMD device 200.

The head tracking system may also support other suitable positioning techniques, such as GPS or other global navigation systems. Further, while specific examples of position sensor systems have been described, it will be appreciated that any other suitable position sensor systems may be used. For example, pose and/or movement data may be determined based on sensor information from any combination of sensors mounted on the wearer and/or external to the wearer including, but not limited to, any number of gyroscopes, accelerometers, inertial measurement units (IMUs), GPS devices, barometers, magnetometers, cameras (e.g., visible light cameras, infrared light cameras, time-of-flight depth cameras, structured light depth cameras, etc.), communication devices (e.g., WI-FI and/or Bluetooth antennas/interfaces), etc.

In some examples, the HMD device 200 may also include an optical sensor system that utilizes one or more outward-facing sensors, such as the color camera 208 or the depth camera 210 on the HMD device 200, to capture image data. The outward-facing sensor(s) may detect movements within its field of view, such as gesture-based inputs or other movements performed by a user or by a person or physical object within the field of view. The outward-facing sensor(s) may also capture 2D image information and depth information from the physical environment and physical objects within the environment.

The optical sensor system may include a depth tracking system that generates depth tracking data via one or more depth cameras. In one example, each depth camera may include the left and right cameras of a stereoscopic vision system. Time-resolved images from one or more of these depth cameras may be registered to each other and/or to images from another optical sensor such as a visible spectrum camera and may be combined to yield depth-resolved video.

In other examples, a structured light depth camera may be configured to project a structured infrared illumination, and to image the illumination reflected from a scene onto which the illumination is projected. A depth map of the scene may be constructed based on spacings between adjacent features in the various regions of an imaged scene. In still other examples, a depth camera may take the form of a time-of-flight depth camera configured to project a pulsed infrared illumination onto a scene and detect the illumination reflected from the scene. For example, modulated illumination may be provided by an infrared light source, and a phase difference between projected and reflected illumination may be used to calculate the time between projecting and detecting the light. It will be appreciated that any other suitable depth camera may be used within the scope of the present disclosure.

The outward-facing sensor(s) may capture images of the physical environment in which a user is situated. With respect to the HMD device 200, in one example, a mixed reality display program may include a 3D modeling system that uses such captured images to generate a virtual environment that models the physical environment surrounding the user.

In one example, the HMD device 200 may include a gaze tracking system configured to detect a direction of gaze of each eye of a user. The gaze detection subsystem may be configured to determine gaze directions of each of a user's eyes in any suitable manner. For example, the gaze detection subsystem may comprise one or more light sources, such as infrared light sources, configured to cause a glint of light to reflect from the cornea of each eye of a user. One or more image sensors may then be configured to capture an image of the user's eyes.

Images of the glints and of the pupils, as determined from image data gathered from the image sensors, may be used to determine an optical axis of each eye. Using this information, the gaze tracking system may then determine a direction in which the user is gazing. The gaze tracking system may additionally or alternatively determine at what physical or virtual object the user is gazing. Such gaze tracking data may then be provided to the HMD device 200.

It will also be understood that the gaze tracking system may have any suitable number and arrangement of light sources and image sensors. For example, the gaze tracking system of the HMD device 200 may utilize at least one inward-facing sensor.

The HMD device 200 may also include a microphone system that includes one or more microphones that capture audio data. In other examples, audio may be presented to the user via one or more speakers, such as audio speakers on the HMD device 200.

In some embodiments, the methods and processes described herein may be tied to one or more computing systems of one or more computing devices. In particular, such methods and processes may be implemented as a computer-application program or service, an application-programming interface (API), a library, and/or other computer-program product.

FIG. 3 illustrates an example of activating a virtual control 300 in a mixed reality environment 302. A dashed boundary 304 represents a user's field of view within a remote control device, such as an HMD device. FIG. 3 shows a single image, such as may be viewed on the display of a mobile phone or tablet computer. However, it should be understood that in a typical HMD device, FIG. 3 could represent a stereo integration of multiple displays rendering the virtual user space in coordination with the physical user space, which can be projected from one or more displays and/or viewable through a translucent or transparent lens of the HMD device.

The scenario illustrated in FIG. 3 assumes that the remote control device (e.g., an HMD device) has been set up to recognize the physical controlled device (e.g., the light 306). Accordingly, when the HMD device detects the localizable beacons from the light 306, the HMD device determines the location of the physical user space, executes the virtual control object for the virtual control 300, and displays the virtual control 300 in the user's field of view, in the proximity of the light 306 (the proximity range from the light 306 is shown by the dotted line circle 308). Displaying the virtual control 300 within the proximity range of the light 306 offers the user a spatial cue suggesting that the virtual control 300 is associated with and able to control the light 306.

Accordingly, if the user wishes to control the light 306, she can raise a finger 310 to interact with the virtual control 300. By “touching” the virtual control 300, the user activates the virtual control 300, which can respond with feedback indicating to the user that the switch has been toggled (e.g., an animation that renders a toggling of the switch, a momentary change in color). It should be understood that the HMD device can optimize placement of the virtual control to be at an arm's-reach distance from the user in the virtual user space, even though the physical device is farther away from the user.

Responsive to detecting that the user has toggled the switch represented by the virtual control 300, the virtual control object executed by the HMD device generates and wirelessly transmits a remote control instruction to the light 306 (e.g., via Bluetooth or Wi-Fi communications). In the case of a two-position virtual switch control, the remote control instruction may simply instruct the light 306 to change its state, although remote control instructions can be rich with information. For example, a virtual slider control may result in the generation and transmission of a percentage of a total slider range or an absolute slider value. A virtual selector control may result in the generation and transmission of a selector value. A virtual button control may result in the generation and transmission of a button value.

Remote control instructions may also include supplemental information (e.g., metadata data and/or parameters) provided by the HMD device and/or other sources. For example, the HMD device may parameterize a remote control instruction differently at different times of day, if other lights are on in the room, or if the drapes are open or closed during daylight hours on a sunny day. The remote control instructions and any parametrization may be configured by the user or an administrator.

Upon receiving the remote control instruction, the light 306 executes the remote control instruction, such as by turning on or off the light bulb.

FIG. 4 illustrates another example of activating a virtual control in a mixed reality environment. A dashed boundary 404 represents a user's field of view within a remote control device, such as an HMD device.

The scenario illustrated in FIG. 4 assumes that the remote control device (e.g., an HMD device) has been set up to recognize the physical controlled device (e.g., the light 406). Accordingly, when the HMD device detects the localizable beacons from the light 406, the HMD device determines the location of the physical user space and executes the virtual control object for the virtual control 400, which in FIG. 4 is transparent, translucent, and/or otherwise rendered (e.g., as an icon, a sparkle, or a shimmer) and overlaid on the light 406. In this implementation, the virtual control 400 predominately or entirely overlaps the light 406 within the user's field of view in the HMD device, effectively using the physical dimensions of the light 406 to represent the position of the virtual control 400. Also, in this implementation, the virtual control 400 is positioned within the smaller proximity range of the light 406 (e.g., the proximity range from the light 406 is shown by the dotted line circle 408). Positioning the virtual control 400 within the small proximity range of the light 406 (in fact, predominately overlapping the light 406) offers the user a spatial cue suggesting that the virtual control 400 is associated with and able to control the light 406. Rather than bring represented by a virtual “switch” control, the virtual control 400 sparkles or shimmers to indicate that the virtual control 400 overlaps the light 406.

Accordingly, if the user wishes to control the light 406, she can raise a finger 410 to interact with the virtual control 400, which is positioned to overlap the bounds of the light 406. By “touching” the virtual control 400 (e.g., “touching” the position of the virtual control 406, whether visible or not), the user activates the virtual control 400, which can respond with feedback indicating to the user that the switch has been toggled (e.g., an animation that renders a change in the sparkle or in the shimmer color).

Responsive to detecting that the user has toggled the switch represented by the virtual control 400, the HMD device generates and wirelessly transmits a remote control instruction to the light 406 (e.g., via Bluetooth or Wi-Fi communications). In the case of a two-position virtual switch control, the remote control instruction may simply instruct the light 406 to change its state, although remote control instructions can be rich with information. For example, a virtual slider control may result in generation and transmission of a percentage of a total slider range or an absolute slider value. A virtual selector control may result in generation and transmission of a selector value. A virtual button control may result in generation and transmission of a button value.

Remote control instructions may also include supplemental information provided by the HMD device and/or other sources. For example, the HMD device may parameterize a remote control instruction differently at different times of day, if other lights are on in the room, or if the drapes are open or closed during daylight hours on a sunny day. The remote control instructions and any parametrization may be configured by the user or an administrator.

Upon receiving the remote control instruction, the light 406 executes the remote control instruction, such as by turning on or off the light bulb.

FIG. 5 illustrates yet another example of activating a virtual control in a mixed reality environment, wherein the virtual control exhibits multiple modes. A dashed boundary 504 represents a user's field of view within a remote control device, such as an HMD device.

The scenario illustrated in FIG. 5 assumes that the remote control device (e.g., an HMD device) has been set up to recognize the physical controlled device (e.g., the light 506). Accordingly, when the HMD device detects the localizable beacons from the light 506, the HMD device determines the location of the physical user space and executes the virtual control object for the virtual control 500, which in FIG. 5 is transparent, translucent, and/or otherwise rendered (e.g., as an icon, a sparkle, or a shimmer) and overlaid on the light 506. In this implementation, the virtual control 500 predominately or entirely overlaps the light 506 within the user's field of view in the HMD device, effectively using the physical dimensions of the light 506 to represent the position of the virtual control 500. Also, in this implementation, the virtual control 500 is positioned within the smaller proximity range of the light 506 (e.g., the proximity range from the light 506 is shown by the dotted line circle 508). Positioning the virtual control 500 within the small proximity range of the light 506 (in fact, predominately overlapping the light 506) offers the user a spatial cue suggesting that the virtual control 500 is associated with and able to control the light 506. Rather than bring represented by a virtual “switch” control, the virtual control 500 sparkles or shimmers to indicate that the virtual control 500 overlaps the light 506.

Accordingly, if the user wishes to control the light 506, she can raise a finger 510 to interact with the virtual control 500, which is positioned to overlap the bounds of the light 506. By “touching” the virtual control 500 (e.g., “touching” the position of the virtual control 506, whether visible or not), the user activates the virtual control 500, which can respond with feedback indicating to the user that the switch has been toggled (e.g., an animation that renders a change in the sparkle or in the shimmer color).

Responsive to detecting that the user has toggled the switch represented by the virtual control 500, the HMD device in FIG. 5 renders a second virtual control 512 within the user's field of view. As with other virtual controls described herein, the user can interact with the second virtual control 512, in this case, to change the color and light intensity of the light 506. Responsive to detecting that the user has changed a control setting provided by the second virtual control 512, the HMD device generates and wirelessly transmits a remote control instruction to the light 506 (e.g., via Bluetooth or Wi-Fi communications). In the case of the virtual slider controls, the remote control instruction may result in generation and transmission of a percentage of a total slider range or an absolute slider value in or with the remote control instructions to the light 506.

Remote control instructions may also include supplemental information provided by the HMD device and/or other sources. For example, the HMD device may parameterize a remote control instruction differently at different times of day, if other lights are on in the room, or if the drapes are open or closed during daylight hours on a sunny day. The remote control instructions and any parametrization may be configured by the user or an administrator.

Upon receiving the remote control instruction, the light 506 executes the remote control instruction, such as by changing the color and/or light intensity emitted by the light bulb.

In an alternative implementation, a virtual control may include audible and/or haptic elements, whether or not in combination with visual virtual control elements. In one implementation, a virtual control may be implemented as an audible voice or sound communicated through the remote control device (e.g., via audio speakers or earphones), directing a visually-impaired user to the location of a physical controlled device in the physical user space, based on the user's position and orientation within the physical user space. The audible virtual control can be associated with the physical controlled device by a verbal label. For example, the virtual control can be implemented as an audible instruction from the remote control device, such as “Speaker #1 is positioned to your right. You may instruct me to adjust the volume of Speaker #1.” If the user provides a verbal command, the remote control device can detect the command as activating the virtual control and therefore generate and transmit a remote control instruction to Speaker #1 to execute the remote control command. Haptic interactions may also be implemented in an analogous fashion.

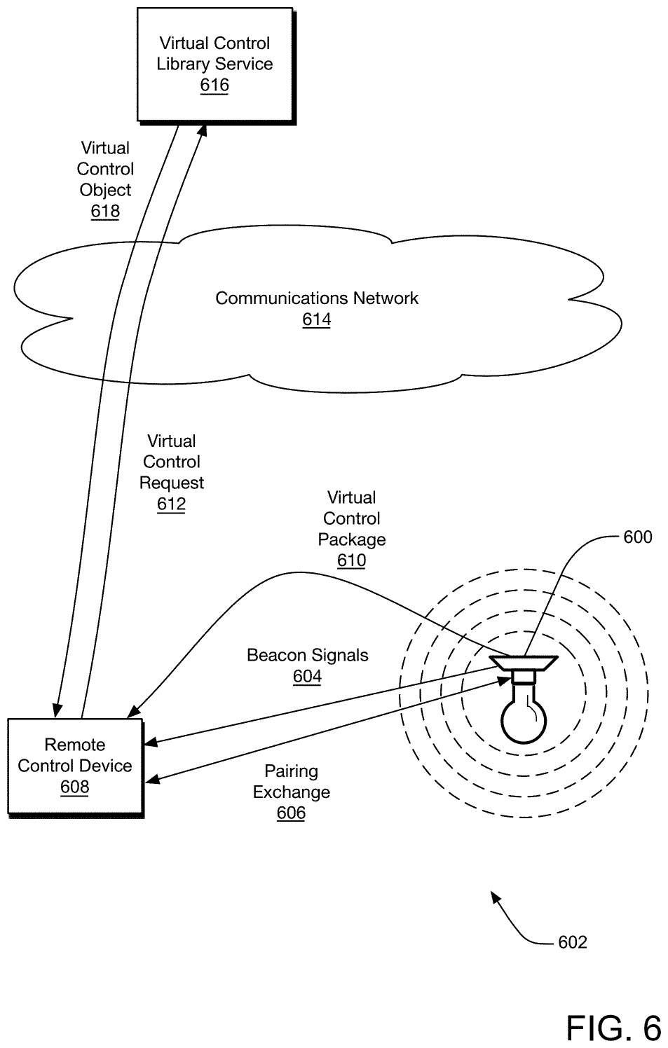

FIG. 6 illustrates an example registration of a virtual control for a physical device (e.g., a light 600) in a mixed reality environment 602. A remote control device (e.g., a remote control device 608, which can take the form of a head-mounted display (HMD) device, a mobile phone, a tablet computer, or another suitable remote control device. A user can view physical objects, such as the light 600) within the physical user space through the remote control device 608. In some implementations, the physical object is viewed through transparent or translucent materials of the remote control device 608 (e.g., see the transparent or translucent shield lens 207 in FIG. 2). The light 600 includes storage, processing features, and communications capabilities to support holographic device control. The light 600 is a physical controlled device that may or may not have physical controls. For example, the light 600 may be connected to a light switch on a wall, although the described technology can make such physical controls unnecessary. The physical controls can be replaced in some designs with virtual controls of a holographic device control solution.

When turned on, the light 600 periodically transmits localizable beacons (e.g., based on Bluetooth 5.1 or other localization technologies) into the physical user space, as depicted by the dashed line circles encircling the light 600. Typically, such localizable beacons have a limited range that would fill most rooms.

If the light 600 has not yet registered with the remote control device 608, upon receiving one or more beacon signals 604 from the physical controlled device, the remote control device 608 can localize the physical controlled device in the physical user space, e.g., within 10 cm accuracy in three dimensions. For example, the remote control device 608 may begin to receive such beacons after entering a room containing physical controlled devices with holographic device control capabilities (e.g., with the light 600). Responsive to receiving such beacon signals, the remote control device 608 can indicate to the user that a physical controlled device is offering to be controlled by holographic device control, including without limitation audio, visual, and/or haptic effects. For example, the remote control device 608 can display a virtual indicator (e.g., an icon, sparkles, a shimmer effect, a translucent color overlay) that visually overlaps or is displayed in visual proximity of the physical controlled device on one or more displays within the user's field of view in the remote control device 608 to indicate that the physical controlled device is offering holographic device control functionality.

Responsive to instructions by the user, such as activating (e.g., touching) the virtual indicator, the remote control device 608 can respond to the physical controlled device's offer by attempting to pair with the physical controlled device, such as via a Bluetooth 5.1 pairing exchange 606. For example, after detecting the activation of the visual indicator, the remote control device 608 can send a Bluetooth pairing request to the physical controlled device (or vice versa) to initiate the pairing operation. Once paired, the remote control device 608 and the physical controlled device can establish a security relationship and a secure communication connection to allow holographic device control of the physical controlled device by the remote control device 608, as will be described below.

Having established a secure communication connection, the remote control device 608 then obtains a virtual control that corresponds to the light 600. A virtual control is a control object (e.g., a digital software object encoding instructions for functional and graphical characteristics of the virtual control) associated with the physical controlled device and is positioned within the user's field of view in the remote control device 608.

The virtual control object that encodes the instructions for positioning, displaying and/or executing the holographic device control functionality may be obtained by the remote control device 608 in a variety of ways. In one implementation, the virtual control object is stored in firmware or other onboard storage of the light 600 and communicated the virtual control object in a virtual control package 610 via the secure communication connection established by the pairing exchange. The virtual control package 610 can also include additional data, including without limitation cryptographic parameters, licensing parameters, customization options, etc. In another implementation, the physical controlled device can communicate a virtual control object identifier (e.g., a URL to a virtual control object library or service from which the remote control device 608 can download the code for the virtual control object associated with the physical controlled device). Accordingly, the remote control device 608 can send a virtual control request 612 through a communications network 614 to a local or remote virtual control library service 616. The virtual control request 612 may be sent to a URL received from the light 600 or to a generic or standard virtual control web service as a known URL. The virtual control request 612 may include a virtual control object identifier or some other information (e.g., light model number, manufacturer) to allow the virtual control library service 616 to find a compatible or supported virtual control object 618 and return it to the remote control device 608. In some implementation, the remote control device 608 may include its own virtual control library, from which it can extract and execute the appropriate virtual control object.

In yet another implementation, the remote control device 608 can recognize a physical pattern (e.g., a QR code or the physical attributes of the device itself, such as a marked model or vendor name, the locations of buttons, and/or device shape) on or associated with the physical controlled device and compare the recognized pattern against patterns of known physical controlled devices. If a match is made, then the remote control device 608 can download a virtual control object associated with that known physical controlled device. The match may be associated with the specific instance of the physical controlled device (e.g., a virtual control object for each unique device), with the type of physical controlled device (e.g., a virtual control object for the same type or similar types of devices), or with generic or standard categories of devices (e.g., simple lighting devices may comply with a generic or standard template of lighting equipment that is mapped to a generic version of a virtual control object for simple lighting devices).

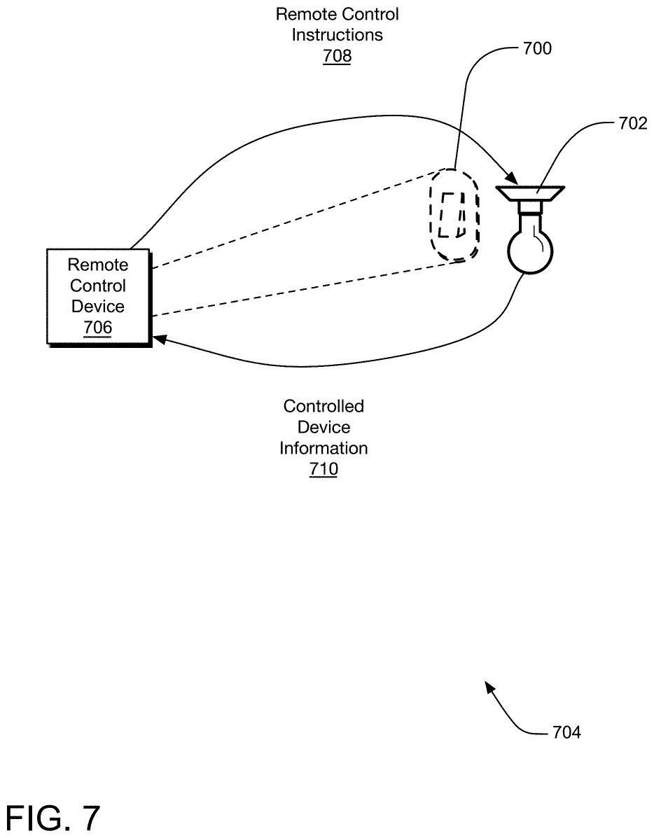

FIG. 7 illustrates an example rendering and activation of a virtual control 700 for a physical device (e.g., a light 702) in a mixed reality environment 704. Having obtained the virtual control object associated with the physical controlled device, hardware processors in a remote control device 706 execute the virtual control object and position the corresponding virtual control 700 (whether visible or invisible) within the user's field of view in the remote control device 706. In one implementation, the remote control device 706 positions the virtual control to overlap the physical controlled device in the user's field of view. In the illustrated implementation, the remote control device 706 positions the virtual control within a proximity region around a view axis (not shown) between the remote control device 706 and the antenna in the light 702.

The user can then activate the virtual control to remotely control the associated physical controlled device. For example, in the case of the virtual switch control (such as virtual control 700), the user can reach forward within her field of view through the remote control device 706 and “touch” the virtual control 700 to turn the light 702 on and off. The interaction of the user's finger and the virtual control 700 is detected by the remote control device 706, which responsively generates and transmits one or more remote control instructions to the light 702. The light 702 may also communicate controlled device information 710, including without limitation, device state information, power levels, sensor data, and security information.

FIG. 8 illustrates example hardware and software components and subsystems of an example remote control device 800 and an example physical controlled device 802. FIG. 8 schematically shows a non-limiting implementation of the example remote control device 800 and the example physical controlled device 802 that can enact one or more of the methods and processes described herein. The remote control device 800 and the physical controlled device 802 are shown in simplified form and may take the form of one or more AR (augmented reality)/VR (virtual reality)/MR (mixed reality) HMD computers, personal computers, server computers, tablet computers, home-entertainment computers, network computing devices, gaming devices, mobile computing devices, mobile communication devices (e.g., smartphone), wearable computing devices, and/or other computing devices. In particular, the example remote control device 800 and the example physical controlled device 802 may be implemented as a mixed reality device and/or a remote computer as described herein. It should also be understood that the hardware and software components and subsystems of these devices may be distributed into separate logical and/physical components.

The remote control device 800 includes one or more hardware processors 804 (e.g., CPUs, CPU cores, microcontrollers, graphics processors) and tangible computer-readable storage media (e.g., storage 806, such as RAM devices or storage memory devices). The remote control device 800 also includes one or more displays 801, a user interface controller 808, a rendering engine 810, a 3D mapping subsystem 812, a remote control engine 814, a pairing subsystem 816, a virtual control management engine 818, a communications interface 820, and/or other components not shown in FIG. 8. The user interface controller 808, the rendering engine 810, the 3D mapping subsystem 812, the remote control engine 814, the pairing subsystem 816, the virtual control management engine 818, and the communications interface 820 may include components that are executable by the one or more hardware processors 804.

The communications interface 820 provides wireless and/or wired communications between the remote control device 800 and the physical controlled device 802, which has its own communications interface 822, and between the remote control device 800 and one or more virtual control libraries and/or services. The communications interfaces include a combination of hardware and software to provide communications between network-connected and/or network-capable devices and systems. The pairing subsystem 816 interacts with pairing subsystems of other devices to establish secure communication connections.

The 3D mapping subsystem 812 maps placement and interaction of physical objects and virtual objects within the mixed reality environment, including as these objects are within the user's field of view. The user interface controller 808 manages user input within the mixed reality environment provided by the remote control device 800. With assistance from the 3D mapping subsystem 812, the user interface controller 808 can detect interactions of physical objects and virtual objects within the user's field of view, for example, to detect user activation of a virtual control by a physical object, like a user's finger.

The rendering engine 810 positions a virtual control associated with the physical controlled device within a visual user space displayed by the remote control device and viewable within a field of view of a user. In various implementations, the virtual control is rendered a transparent, translucent, opaque, or combinations thereof. When the virtual control is visible, the rendering engine 810 displays the virtual control on the one or more displays 801. The rendering engine 810 may also display physical objects in combination with virtual objects within the one or more displays 801.

The remote control engine 814 generates a remote control instruction representing the user activation of the virtual control by the user. The remote control instruction is supported by the physical controlled device 802 to perform the user activation operation on the physical controlled device 802. The virtual control management engine 818 interacts with the physical controlled device 802 to identify and obtain (e.g., download, receive) a virtual control object that implements the virtual control associated with the physical controlled device 802. For example, the virtual control management engine 818 may receive the virtual control object from the physical controlled device 802 and execute the virtual control object on the remote control device 800 to implement the virtual control of the physical controlled device 802. In other examples, the virtual control management engine 818 may retrieve the virtual control object from a local or remote virtual control library or library service based on information provided by the physical controlled device 802 and then execute the virtual control object on the remote control device 800 to implement the virtual control of the physical controlled device 802.

The physical controlled device 802, such as a remote-controllable light, microwave oven, industrial valve, etc., includes one or more hardware processors 824 (e.g., CPUs, CPU cores, microcontrollers, graphics processors) and tangible computer-readable storage media (e.g., storage 826, such as RAM devices or storage memory devices). The physical controlled device 802 also includes a pairing subsystem 828 that interacts with the pairing subsystem 816 of the remote control device to establish a secure communication connection.

A device control subsystem 830 receives (e.g., through the communications interface 822) and executes remote control instructions (e.g., through electronic connections and/or APIs to other software executing on the physical controlled device 802. The device control subsystem 830 can also receive configuration update data, software updates, and other data from the remote control device. The device control subsystem 830 also communicates controlled device information to the remote control device 800, such as device states, configurations, and sensed data from the physical controlled device 802. Such instructions, data, and updates are communicated via the secure communication connection via the communication interfaces.

The pairing subsystem 828 and the device control subsystem may include components that are executable by the one or more hardware processors 824.

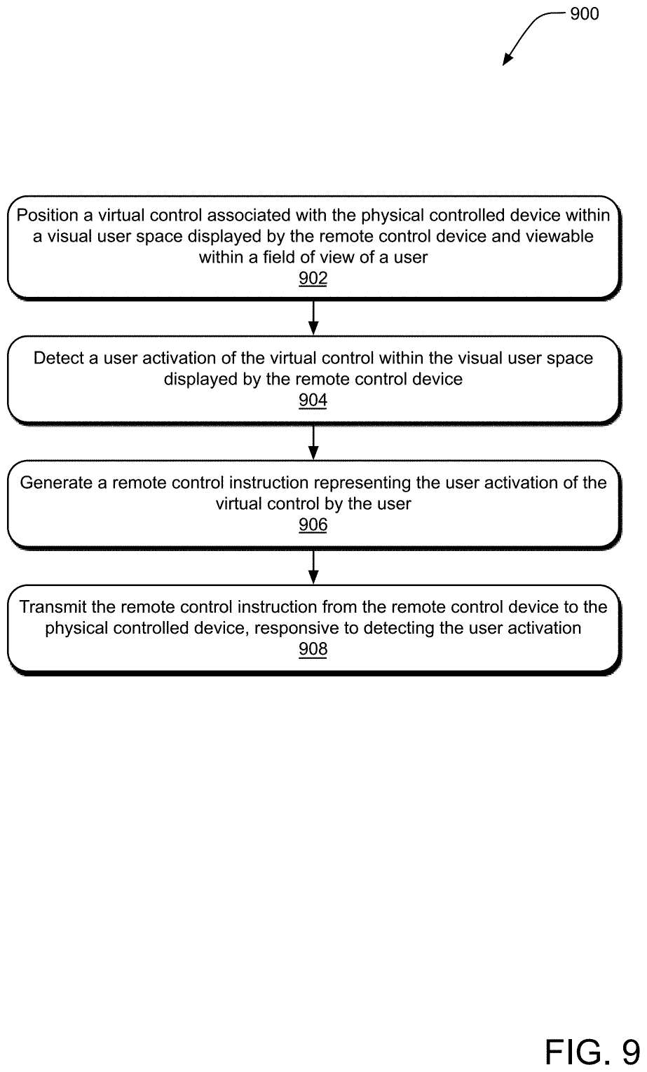

FIG. 9 illustrates example operations 900 for remotely controlling a physical controlled device in a physical user space using a virtual control in a mixed reality environment. A positioning operation 902 positions a virtual control associated with a physical control device within a visual user space displayed by the remote control device. The visual user space is viewable within the user's field of view within the remote control device. The virtual control may be transparent, translucent, or opaque within the remote control device. Furthermore, the appearance, shape, and position of the virtual control can change over time or depend on user interactions or state changes of the physical device (e.g., a timed cooking cycle ends in a microwave oven, so the color of the virtual control changes to reflect this). In some implementations, the virtual control is initially displayed in proximity to the physical controlled device in the user's field of view, although the user can move the virtual control to be positioned in other locations within the user's visual space (e.g., moving the virtual control to be displayed on a physical wall near a doorway in the room).

A detecting operation 904 detects a user activation of the virtual control. For example, an HMD device can overlay a virtual user space on a physical user space, such that a user can view virtual objects in combination with physical objects to provide a mixed reality environment. In another example, a mobile phone with a front-facing camera can capture video of the physical user space and overlay a virtual user space over the physical user space on the mobile phone's display to provide a mixed reality environment. Furthermore, in mixed reality environments, the HMD device or mobile phone can detect user activation of virtual controls by tracking a user's finger relative to the generated virtual controls.

A generating operation 906 generates a remote control instruction representing the detected user activation of the virtual control by the user. For example, if the user activation represents a toggling of an on/off switch, then the generating operation 906 can generate a remote control instruction that can be understood by the physical controlled device to toggle its on/off state. A transmitting operation 908 transmits the generated remote control instruction from the remote control device to the physical controlled device, which can execute the remote control instruction to effect the desired result of the user activation (e.g., turning the physical controlled device on or off).

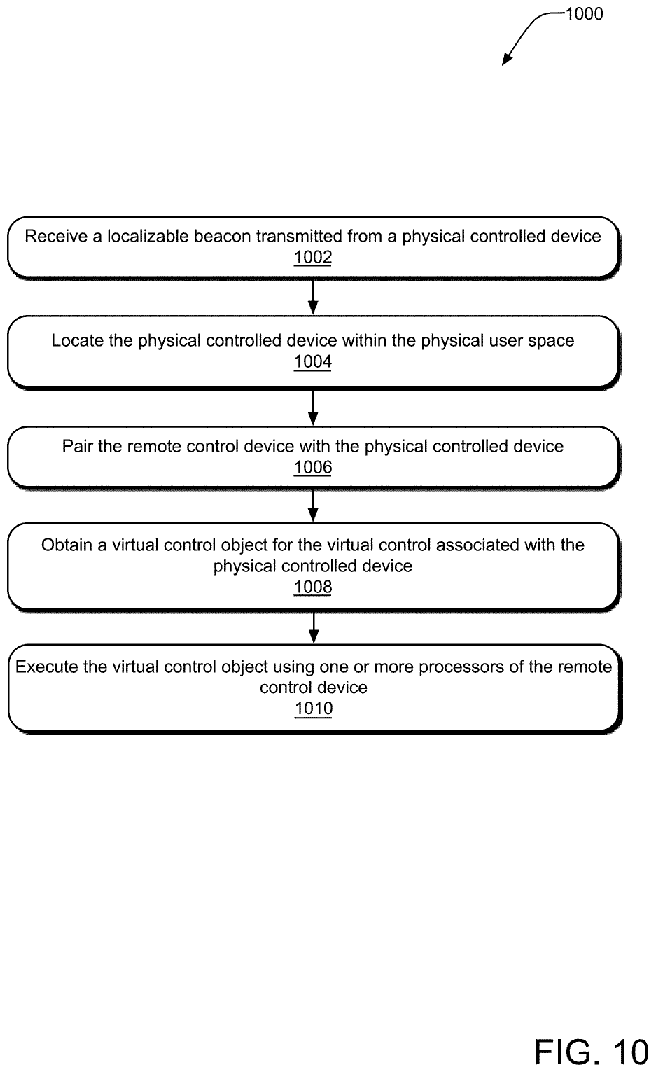

FIG. 10 illustrates example operations 1000 for executing a virtual control object associated with a physical controlled device in a mixed reality environment. A receiving operation 1002 receives a localizable beacon from the physical controlled device at a remote control device. A locating operation 1004 locates the physical controlled device within the physical user space, such as using Bluetooth 5.1 direction-finding. A pairing operation 1006 pairs the remote control device with the physical controlled device, establishing a secure communication connection between them.

A virtual control operation 1008 obtains a virtual control object for the virtual control associated with the physical controlled device so that the remote control device has the program code and data needed to operate the virtual control within the mixed reality environment. In one implementation, the virtual control object is received from storage in the physical controlled device via the secure communication connection. In another implementation, the virtual control object is requested and received from a virtual control library based on information received from the physical controlled object. Such information may include a URL to a virtual control library service, an identifier of the physical controlled device (e.g., a model number, a virtual control identifier), or other information. In yet another implementation, the remote control device recognizes a pattern provided by the physical controlled device, such as a QR code or recognized features of the device's design (e.g., a specific control panel, placement of physical structures) and, therefore, the remote control device can request and receive the virtual control object that is associated with the recognized pattern. An execution operation 1010 executes the virtual control object using one or more processors of the remote control device.

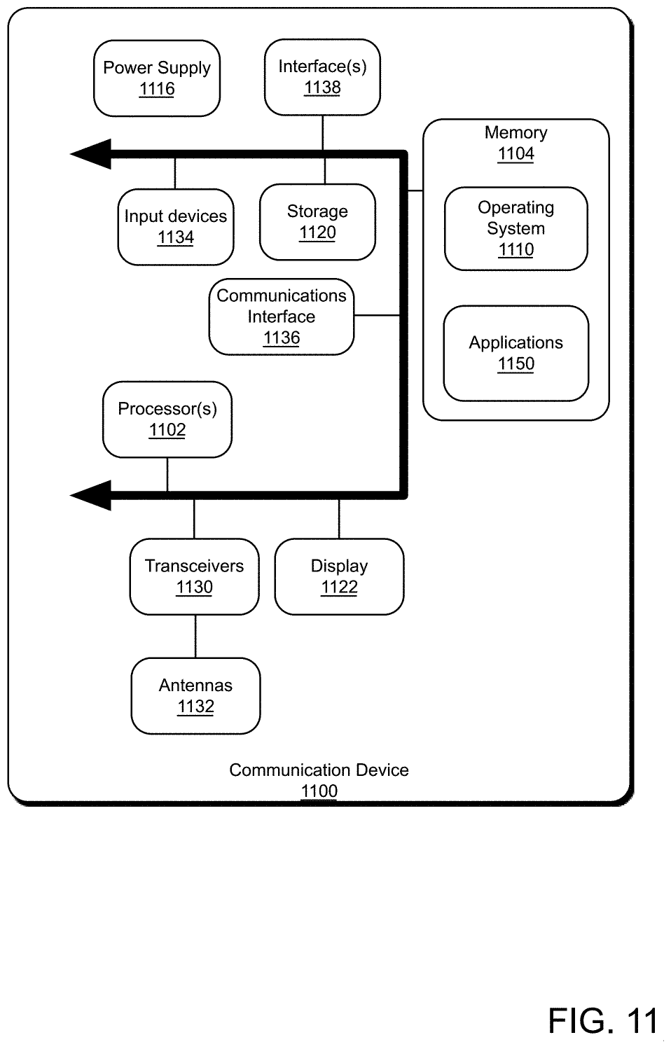

FIG. 11 illustrates an example communication device 1100 for implementing the features and operations of the described technology. The communication device 1100 may embody a remote control device or a physical controlled device and is an example network-connected and/or network-capable device and may be a client device, such as a laptop, mobile device, desktop, tablet; a server/cloud device; an internet-of-things device; an electronic accessory; or another electronic device. The communication device 1100 includes one or more processor(s) 1102 and a memory 1104. The memory 1104 generally includes both volatile memory (e.g., RAM) and nonvolatile memory (e.g., flash memory). An operating system 1110 resides in the memory 1104 and is executed by the processor(s) 1102.

In an example communication device 1100, as shown in FIG. 11, one or more modules or segments, such as applications 1150, the user interface controller, the rendering engine, the 3D mapping subsystem, the remote control engine, the pairing subsystem, the virtual control management engine, the device control subsystem, and other services, workloads, and modules, are loaded into the operating system 1110 on the memory 1104 and/or storage 1120 and executed by processor(s) 1102. The storage 1120 may include one or more tangible storage media devices and may store cryptographic security parameters, 3D maps, virtual control objects, device parameters, and other data and be local to the communication device 1100 or may be remote and communicatively connected to the communication device 1100.

The communication device 1100 includes a power supply 1116, which is powered by one or more batteries or other power sources and which provides power to other components of the communication device 1100. The power supply 1116 may also be connected to an external power source that overrides or recharges the built-in batteries or other power sources.

The communication device 1100 may include one or more communication transceivers 1130 which may be connected to one or more antenna(s) 1132 to provide network connectivity (e.g., mobile phone network, Wi-Fi®, Bluetooth®) to one or more other servers and/or client devices (e.g., mobile devices, desktop computers, or laptop computers). The communication device 1100 may further include a network adapter 1136, which is a type of communication device. The communication device 1100 may use the adapter and any other types of communication devices for establishing connections over a wide-area network (WAN) or local-area network (LAN). It should be appreciated that the network connections shown are exemplary and that other communication devices and means for establishing a communications link between the communication device 1100 and other devices may be used.

The communication device 1100 may include one or more input devices 1134 such that a user may enter commands and information (e.g., a keyboard or mouse). These and other input devices may be coupled to the server by one or more interfaces 1138, such as a serial port interface, parallel port, or universal serial bus (USB). The communication device 1100 may further include a display 1122, such as a touch screen display.

The communication device 1100 may include a variety of tangible processor-readable storage media and intangible processor-readable communication signals. Tangible processor-readable storage can be embodied by any available media that can be accessed by the communication device 1100 and includes both volatile and nonvolatile storage media, removable and non-removable storage media. Tangible processor-readable storage media excludes communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the communication device 1100. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a remote control device and/or a physical controlled device 802 implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across multiple user sessions. A service may be available to one or more system components, programs, and/or other services. In some implementations, a service may run on one or more server computing devices.

While this specification contains many specific implementation details, these should not be construed as limitations on the scope of any inventions or of what may be claimed, but rather as descriptions of features specific to particular embodiments of a particular described technology. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

An example method of remotely controlling a physical controlled device in a physical user space using a virtual control in a mixed reality environment is provided. The method includes positioning, by a remote control device, the virtual control associated with the physical controlled device within a visual user space presented by the remote control device within a field of view of a user; detecting, by the remote control device, a first user activation of the virtual control within the visual user space; generating a remote control instruction representing the first user activation of the virtual control, the remote control instruction being supported by the physical controlled device to perform the first user activation on the physical controlled device; and transmitting the remote control instruction from the remote control device to the physical controlled device, responsive to detecting the first user activation.

Another example method of any preceding method is provided, further comprising, prior to the positioning operation, receiving, at the remote control device, a localizable beacon transmitted from the physical controlled device; obtaining, at the remote control device, a virtual control object for the virtual control associated with the physical controlled device; and executing the virtual control object using one or more processors of the remote control device.

Another example method of any preceding method is provided, wherein the virtual control object is obtained by the remote control device from the physical controlled device.

Another example method of any preceding method is provided, wherein the virtual control object is obtained by the remote control device from a virtual control library based on information provided by the physical controlled device.

Another example method of any preceding method is provided, wherein the virtual control object is obtained by the remote control device from a virtual control library based on pattern recognition performed by the remote control device on the physical controlled device.

Another example method of any preceding method is provided, wherein the positioning operation includes displaying the virtual control within the visual user space.

Another example method of any preceding method is provided, wherein the positioning operation includes displaying the virtual control in a visual proximity of the physical controlled device within the visual user space.

Another example method of any preceding method is provided, wherein the visual proximity is based on a predefined proximity range from an antenna of the physical controlled device within the visual user space.

Another example method of any preceding method is provided, wherein the positioning operation includes positioning the virtual control to at least predominately overlap the physical controlled device within the visual user space.

Another example method of any preceding method is provided, further including displaying, by the remote control device, a second virtual control associated with the physical controlled device within the visual user space displayed by the remote control device and viewable within the field of view of the user, responsive to detecting the first user activation; and detecting, by the remote control device, a second user activation of the second virtual control within the visual user space displayed by the remote control device and viewable within the field of view of the user, responsive to displaying the second virtual control, wherein the generating operation and the transmitting operation are responsive to detecting the second user activation.

Another example method of any preceding method is provided, wherein the remote control device is a head mounted display device.

An example system for remotely controlling a physical controlled device in a physical user space using a virtual control in a mixed reality environment is provided. The system includes one or more hardware processor; a rendering engine executed by the one or more hardware processors and configured to position the virtual control associated with the physical controlled device within a visual user space presented by a remote control device within a field of view of a user; a user interface controller executed by the one or more hardware processors and configured to detect a first user activation of the virtual control within the visual user space displayed by the remote control device; a remote control engine executed by the one or more hardware processors and configured to generate a remote control instruction representing the first user activation of the virtual control, the remote control instruction being supported by the physical controlled device to perform the first user activation on the physical controlled device; and a communications interface configured to transmit the remote control instruction from the remote control device to the physical controlled device, responsive to detecting the first user activation.

Another example system of any preceding system is provided, wherein the communications interface is further configured to receive a localizable beacon transmitted from the physical controlled device, and further including a virtual control management engine executed by the one or more hardware processors and configured to obtain a virtual control object for the virtual control associated with the physical controlled device and to execute the virtual control object using one or more processors of the remote control device, prior to positioning the virtual control.

Another example system of any preceding system is provided, wherein the user interface controller is further configured to display a second virtual control associated with the physical controlled device within the visual user space displayed by the remote control device and viewable within the field of view of the user, responsive to detecting the first user activation, and to detect a second user activation of the second virtual control within the visual user space displayed by the remote control device and viewable within the field of view of the user, responsive to displaying the second virtual control.

One or more example tangible processor-readable storage media of a tangible article of manufacture encoding processor-executable instructions for executing on an electronic computing device a process of remotely controlling a physical controlled device in a physical user space using a virtual control in a mixed reality environment are provided. The process includes associating, in a remote control device, the virtual control with the physical controlled device; detecting, by the remote control device, a first user activation of the virtual control; generating a remote control instruction representing the first user activation of the virtual control, the remote control instruction being supported by the physical controlled device to perform the first user activation on the physical controlled device; and transmitting the remote control instruction from the remote control device to the physical controlled device, responsive to detecting the first user activation.

Other one or more example tangible processor-readable storage media of any preceding media are provided, wherein the associating operation includes positioning, by the remote control device, the virtual control associated with the physical controlled device within a visual user space presented by the remote control device within a field of view of a user.

Other one or more example tangible processor-readable storage media of any preceding media are provided, wherein the process further includes, prior to the positioning operation, receiving, at the remote control device, a localizable beacon transmitted from the physical controlled device; obtaining, at the remote control device, a virtual control object for the virtual control associated with the physical controlled device; and executing the virtual control object using one or more processors of the remote control device.

Other one or more example tangible processor-readable storage media of any preceding media are provided, wherein the positioning operation includes displaying the virtual control in a visual proximity of the physical controlled device within the visual user space.

Other one or more example tangible processor-readable storage media of any preceding media are provided, wherein the positioning operation includes positioning the virtual control to at least predominately overlap the physical controlled device within the visual user space.

Other one or more example tangible processor-readable storage media of any preceding media are provided, wherein the process further includes displaying, by the remote control device, a second virtual control associated with the physical controlled device within the visual user space displayed by the remote control device and viewable within the field of view of the user, responsive to detecting the first user activation; and detecting, by the remote control device, a second user activation of the second virtual control within the visual user space displayed by the remote control device and viewable within the field of view of the user, responsive to displaying the second virtual control, wherein the generating operation and the transmitting operation are responsive to detecting the second user activation.

An example system of remotely controlling a physical controlled device in a physical user space using a virtual control in a mixed reality environment is provided. The system includes means for positioning, by a remote control device, the virtual control associated with the physical controlled device within a visual user space presented by the remote control device within a field of view of a user; means for detecting, by the remote control device, a first user activation of the virtual control within the visual user space; means for generating a remote control instruction representing the first user activation of the virtual control, the remote control instruction being supported by the physical controlled device to perform the first user activation on the physical controlled device; and means for transmitting the remote control instruction from the remote control device to the physical controlled device, responsive to detecting the first user activation.

Another example system of any preceding system is provided, further including means for receiving, at the remote control device, a localizable beacon transmitted from the physical controlled device; means for obtaining, at the remote control device, a virtual control object for the virtual control associated with the physical controlled device; and means for executing the virtual control object using one or more processors of the remote control device.

Another example system of any preceding system is provided, wherein the virtual control object is obtained by the remote control device from the physical controlled device.

Another example system of any preceding system is provided, wherein the virtual control object is obtained by the remote control device from a virtual control library based on information provided by the physical controlled device.

Another example system of any preceding system is provided, wherein the virtual control object is obtained by the remote control device from a virtual control library based on pattern recognition performed by the remote control device on the physical controlled device.

Another example system of any preceding system is provided, wherein the means for positioning includes means for displaying the virtual control within the visual user space.

Another example system of any preceding system is provided, wherein the means for positioning includes means for displaying the virtual control in a visual proximity of the physical controlled device within the visual user space.

Another example system of any preceding system is provided, wherein the visual proximity is based on a predefined proximity range from an antenna of the physical controlled device within the visual user space.

Another example system of any preceding system is provided, wherein the means for positioning includes means for positioning the virtual control to at least predominately overlap the physical controlled device within the visual user space.

Another example system of any preceding system is provided, further including means for displaying, by the remote control device, a second virtual control associated with the physical controlled device within the visual user space displayed by the remote control device and viewable within the field of view of the user, responsive operation of the means for detecting the first user activation; and means for detecting, by the remote control device, a second user activation of the second virtual control within the visual user space displayed by the remote control device and viewable within the field of view of the user, responsive to displaying the second virtual control, wherein the means for generating and the means for transmitting operate responsive to operation of the means for detecting the second user activation.

Another example system of any preceding system is provided, wherein the remote control device is a head mounted display device.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method of remotely controlling a physical controlled device in a physical user space using a virtual control in a mixed reality environment, the method comprising:
positioning, by a remote control device, the virtual control associated with the physical controlled device within a visual user space presented by the remote control device within a field of view of a user;
detecting, by the remote control device, a first user activation of the virtual control within the visual user space;
generating a remote control instruction representing the first user activation of the virtual control, the remote control instruction being supported by the physical controlled device to perform the first user activation on the physical controlled device; and
transmitting the remote control instruction from the remote control device to the physical controlled device, responsive to detecting the first user activation.

2. The method of claim 1, further comprising, prior to the positioning operation:
receiving, at the remote control device, a localizable beacon transmitted from the physical controlled device;
obtaining, at the remote control device, a virtual control object for the virtual control associated with the physical controlled device; and
executing the virtual control object using one or more processors of the remote control device.

3. The method of claim 2, wherein the virtual control object is obtained by the remote control device from the physical controlled device.

4. The method of claim 2, wherein the virtual control object is obtained by the remote control device from a virtual control library based on information provided by the physical controlled device.

5. The method of claim 2, wherein the virtual control object is obtained by the remote control device from a virtual control library based on pattern recognition performed by the remote control device on the physical controlled device.

6. The method of claim 1, wherein the positioning operation comprises:
displaying the virtual control within the visual user space.

7. The method of claim 1, wherein the positioning operation comprises:
displaying the virtual control in a visual proximity of the physical controlled device within the visual user space.

8. The method of claim 7, wherein the visual proximity is based on a predefined proximity range from an antenna of the physical controlled device within the visual user space.

9. The method of claim 1, wherein the positioning operation comprises:
positioning the virtual control to at least predominately overlap the physical controlled device within the visual user space.

10. The method of claim 1, further comprising:
displaying, by the remote control device, a second virtual control associated with the physical controlled device within the visual user space displayed by the remote control device and viewable within the field of view of the user, responsive to detecting the first user activation; and
detecting, by the remote control device, a second user activation of the second virtual control within the visual user space displayed by the remote control device and viewable within the field of view of the user, responsive to displaying the second virtual control, wherein the generating operation and the transmitting operation are responsive to detecting the second user activation.

11. The method of claim 1, wherein the remote control device is a head mounted display device.

12. A system for remotely controlling a physical controlled device in a physical user space using a virtual control in a mixed reality environment, the system comprising:
one or more hardware processors;
a rendering engine executed by the one or more hardware processors and configured to position the virtual control associated with the physical controlled device within a visual user space presented by a remote control device within a field of view of a user;
a user interface controller executed by the one or more hardware processors and configured to detect a first user activation of the virtual control within the visual user space displayed by the remote control device;
a remote control engine executed by the one or more hardware processors and configured to generate a remote control instruction representing the first user activation of the virtual control, the remote control instruction being supported by the physical controlled device to perform the first user activation on the physical controlled device; and
a communications interface configured to transmit the remote control instruction from the remote control device to the physical controlled device, responsive to detecting the first user activation.

13. The system of claim 12, wherein the communications interface is further configured to receive a localizable beacon transmitted from the physical controlled device, and further comprising:
a virtual control management engine executed by the one or more hardware processors and configured to obtain a virtual control object for the virtual control associated with the physical controlled device and to execute the virtual control object using one or more processors of the remote control device, prior to positioning the virtual control.

14. The system of claim 12, wherein the user interface controller is further configured to display a second virtual control associated with the physical controlled device within the visual user space displayed by the remote control device and viewable within the field of view of the user, responsive to detecting the first user activation, and to detect a second user activation of the second virtual control within the visual user space displayed by the remote control device and viewable within the field of view of the user, responsive to displaying the second virtual control.

15. One or more tangible processor-readable storage media of a tangible article of manufacture encoding processor-executable instructions for executing on an electronic computing device a process of remotely controlling a physical controlled device in a physical user space using a virtual control in a mixed reality environment, the process comprising:
associating, in a remote control device, the virtual control with the physical controlled device;
detecting, by the remote control device, a first user activation of the virtual control;
generating a remote control instruction representing the first user activation of the virtual control, the remote control instruction being supported by the physical controlled device to perform the first user activation on the physical controlled device; and
transmitting the remote control instruction from the remote control device to the physical controlled device, responsive to detecting the first user activation.

16. The one or more tangible processor-readable storage media of claim 15, wherein the associating operation comprises:
positioning, by the remote control device, the virtual control associated with the physical controlled device within a visual user space presented by the remote control device within a field of view of a user.

17. The one or more tangible processor-readable storage media of claim 16, wherein the process further comprises, prior to the positioning operation:
receiving, at the remote control device, a localizable beacon transmitted from the physical controlled device;
obtaining, at the remote control device, a virtual control object for the virtual control associated with the physical controlled device; and
executing the virtual control object using one or more processors of the remote control device.

18. The one or more tangible processor-readable storage media of claim 16, wherein the positioning operation comprises:
displaying the virtual control in a visual proximity of the physical controlled device within the visual user space.

19. The one or more tangible processor-readable storage media of claim 16, wherein the positioning operation comprises:
positioning the virtual control to at least predominately overlap the physical controlled device within the visual user space.

20. The one or more tangible processor-readable storage media of claim 16, wherein the process further comprises:
displaying, by the remote control device, a second virtual control associated with the physical controlled device within the visual user space displayed by the remote control device and viewable within the field of view of the user, responsive to detecting the first user activation; and
detecting, by the remote control device, a second user activation of the second virtual control within the visual user space displayed by the remote control device and viewable within the field of view of the user, responsive to displaying the second virtual control, wherein the generating operation and the transmitting operation are responsive to detecting the second user activation.
